(19) United States
(12) Patent Application Publication
(10) Pub. No.: US 2023/0082962 A1
(43) Pub. Date: Mar. 16, 2023

(54) Battery Module

(71) Applicants: Hyundai Motor Company, Seoul (KR); Kia Corporation, Seoul (KR)

(72) Inventor: Hyun Chang KANG, Seoul (KR)

(21) Appl. No.: 17/742,561

(22) Filed: May 12, 2022

(30) Foreign Application Priority Data
Sep. 10, 2021 (KR) 10-2021-0121054

(51) Int. Cl. H01M 10/04; H01M 50/293; H01M 50/211; H01M 10/655; H01M 10/48

(52) U.S. Cl. CPC H01M 10/0481; H01M 50/293; H01M 50/211; H01M 10/655; H01M 10/482

(57) ABSTRACT

An embodiment battery module including two side panels, a plurality of battery cells stacked between the two side panels, a plurality of foams inserted between the battery cells, an upper cover plate coupled to the two side panels and configured to restrain a compressed-stacked state of the battery cells at an upper side of the battery cells in combination with the two side panels, and a lower cover plate coupled to the two side panels and configured to restrain the compressed-stacked state of the battery cells at a lower side of the battery cells in combination with the two side panels.

### CROSS-REFERENCE TO RELATED APPLICATIONS

This application claims the benefit of Korean Patent Application No. 10-2021-0121054, filed on Sep. 10, 2021, which application is hereby incorporated herein by reference.

### TECHNICAL FIELD

The present invention relates generally to a battery module.

### BACKGROUND

A battery module is composed of a plurality of stacked battery cells. The battery module is configured to perform cooling while ensuring structural safety of the stacked battery cells and includes assembly of various components preventing swelling of the battery cells.

In general, the battery module has a preset predetermined size and an output voltage thereof is determined to be constant in response to the size of the battery module.

The foregoing described as the battery module is intended merely to aid in the understanding of the background of the present invention, and is not intended to mean that the present invention falls within the purview of the related art that is already known to those skilled in the art.

### SUMMARY

Embodiments of the present invention provide a battery module configured to minimize the number of components required for maintaining a stacked battery cell structure and ensuring cooling performance, thus to reduce a manufacturing cost, and to easily adjust the number of stacked battery cells to efficiently provide various output voltages and efficiently respond to battery systems with different request output values, and to be improved in durability and to be excellent in maintainability.

According to one embodiment of the present invention, there is provided a battery module including two side panels, a plurality of battery cells compressed-stacked between the two side panels, a plurality of foams inserted between the battery cells, an upper cover plate coupled to the two side panels to restrain a compressed-stacked state of the plurality of battery cells at an upper side of the battery cells together with the two side panels, and a lower cover plate coupled to the two side panels to restrain the compressed-stacked state of the plurality of battery cells at a lower side of the battery cells together with the two side panels.

The plurality of foams and the plurality of battery cells may be repeatedly stacked in order of ‘foams—a battery cell—a battery cell’.

An initial compression force achieving the compressed-stacked state of the plurality of battery cells may be equal to or greater than a predetermined reference compression force, and the foams may be inserted between the battery cells so that the battery cells in the compressed-stacked state may be spaced apart from each other by a predetermined minimum cooling interval or more.

Each of the foams may be made of a material in which a compression rate thereof may be less than or equal to 30% with respect to the reference compression force, and enabled to be additionally increased to be equal to or higher than 30% as compression force between the battery cells is increased.

Each of the foams may be made of at least one of urethane and silicone.

Each of the foams may include at least one of a metal material with excellent thermal conductivity and a carbon-based material.

The foams may be arranged to be overlapped with 30% or more of an effective sectional area composed of a cup portion of each of the battery cells.

The foam inserted between two battery cells adjacent to each other may include a plurality of separate foams configured to provide cooling channels between two battery cells.

The foams may be arranged to surround an outer edge of the cup portion of the battery cell.

Each of the upper cover plate and the lower cover plate may have cooling holes that may be open to communicate with the cooling channels formed by the foams.

Each of the cooling holes of the lower cover plate may be formed in a size larger than a size of each of the cooling holes of the upper cover plate.

Each of the upper cover plate and the lower cover plate may have additional cooling holes that may be open to communicate with empty spaces provided by tap portions of the stacked battery cells.

Each of the side panels may have upper and lower protrusions integrally formed on upper and lower ends thereof, the upper and lower protrusions being inserted into the cooling holes of the upper cover plate and the lower cover plate.

The upper cover plate and the lower cover plate may respectively have wings integrally formed thereon to cover upper and lower end portions of the side panels.

Each of the side panels may have locking protrusions protruding toward the wings of the upper cover plate and the lower cover plate, and the wings of the upper cover plate and the lower cover plate may respectively have locking holes into which the locking protrusions may be inserted.

Bridges may be arranged between the cooling holes of each of the upper cover plate and the lower cover plate and each of the bridges may be formed in a width equal to or greater than a width of the foam.

A filling material may be filled to remove empty spaces between the bridges of each of the upper cover plate and the lower cover plate and the foams.

Sensing boards to which electrodes of the battery cells may be connected may be respectively provided at tap portions at opposite sides of the stacked battery cells, and sensing board covers may be located outside the sensing boards while surrounding the sensing boards.

According to one embodiment of the present invention, there is provided a battery system configured by using the battery module, the battery system including end plates respectively located at opposite ends of a plurality of stacked battery modules.

The battery system may include straps configured to connect the end plates to each other at the opposite ends of the battery cells, thus integrally holding the end plates and the battery modules.

According to embodiments of the present invention, the battery module is configured to minimize the number of the components required for maintaining the stacked battery cell structure and ensuring the cooling performance, thus reducing the manufacturing cost of the battery module, and easily adjusting the number of the stacked battery cells to efficiently provide various output voltages. Therefore, the battery module can efficiently respond to battery systems with various request output values, and is improved in durability, and is excellent in maintainability.

### BRIEF DESCRIPTION OF THE DRAWINGS

The above and other objectives, features, and other advantages of embodiments of the present invention will be more clearly understood from the following detailed description when taken in conjunction with the accompanying drawings, in which:

FIG. 1 is an exploded-perspective view showing a battery module according to an embodiment of the present invention;

FIG. 2 is a view showing a staking structure of battery cells and foams of FIG. 1;

FIGS. 3 and 4 are views sequentially showing a process in which the battery cells stacked between side panels are compressed and are assembled with an upper cover plate and a lower cover plate;

FIG. 5 is a view showing an example of a stacking order of the battery cells and the foams;

FIG. 6 is a view showing cooling channels formed between the battery cells by the foams;

FIG. 7 is a graph showing the tendency of reduction in capacity of the battery module as the number of charging and discharging cycles of the battery module for each an initial compression force volume of the foams;

FIG. 8 is a graph showing relationship between the compression force and the compression rate of a material of the foams;

FIG. 9 is a view showing an example of a structure of each of the battery cells;

FIG. 10 is a view showing the foams overlapped with the battery cells of FIG. 9;

FIG. 11 is a view showing the tendency of reduction in capacity of the battery module as the number of charging and discharging cycles of the battery module for each percentage of area in which the foams are overlapped to the battery cells with respect to an effective sectional area of the battery cell;

FIG. 12 is a sectional view taken along line A-A in FIG. 9;

FIG. 13 is a sectional view taken along line B-B in FIG. 9;

FIG. 14 is a detailed view showing part C in FIG. 10;

FIG. 15 is a view showing a section in a D direction in FIG. 14;

FIG. 16 is an upper perspective view showing an assembled state of the battery module according to embodiments of the present invention;

FIG. 17 is a lower perspective view showing the battery module in FIG. 16;

FIG. 18 is a plan view showing an upper side of the battery module in FIG. 16;

FIG. 19 is a view showing an air flow path formed in the battery module according to an embodiment of the present invention;

FIG. 20 is a view showing a section in an E direction in FIG. 16, and showing a filling material filled between the bridges and the foams;

FIG. 21 is a view showing a battery system using the battery module according to embodiments of the present invention;

FIG. 22 is a view showing a battery system using the battery module according to another embodiment of the present invention; and

FIG. 23 is an exploded-perspective view of the battery system of FIG. 22.

### DETAILED DESCRIPTION OF ILLUSTRATIVE EMBODIMENTS

In the following description, the structural or functional description specified to exemplary embodiments according to the concept of the present invention is intended to describe the exemplary embodiments, so it should be understood that the present invention may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present invention are not limited to the embodiments which will be described hereinbelow with reference to the accompanying drawings, but all modifications, equivalents, and substitutions are included in the scope and spirit of the invention.

It will be understood that, although the terms first and/or second, etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It is to be understood that when one element is referred to as being “connected to” or “coupled to” another element, it may be connected directly to or coupled directly to another element or be connected to or coupled to another element, having an additional element intervening therebetween. On the other hand, it is to be understood that when one element is referred to as being “connected directly to” or “coupled directly to” another element, it may be connected to or coupled to another element without the additional element intervening therebetween. Further, the terms used herein to describe a relationship between elements, that is, “between”, “directly between”, “adjacent”, or “directly adjacent” should be interpreted in the same manner as those described above.

The terminology used herein is for the purpose of describing particular embodiments only and is not intended to limit the present invention. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meaning as commonly understood by those skilled in the art to which the present invention belongs. It must be understood that the terms defined by the dictionary are identical with the meanings within the context of the related art, and they should not be ideally or excessively formally defined unless the context clearly dictates otherwise.

Exemplary embodiments will be described hereafter in detail with reference to the accompanying drawings. Like reference numerals given in the drawings indicate like components.

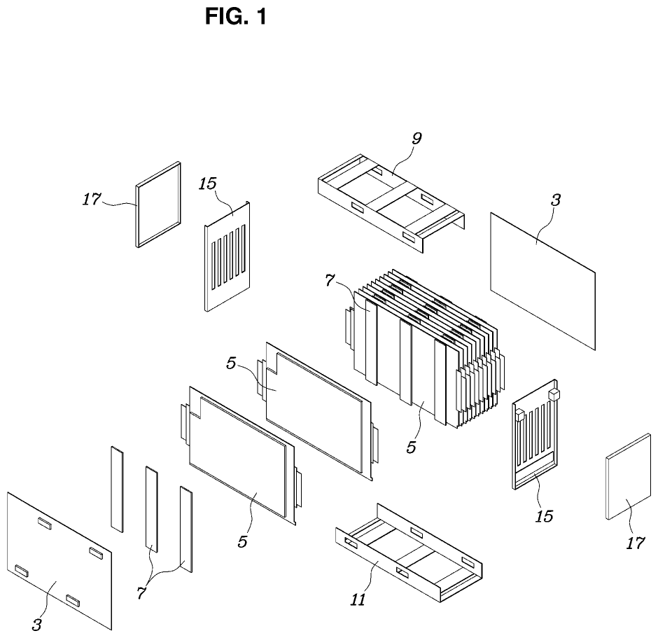

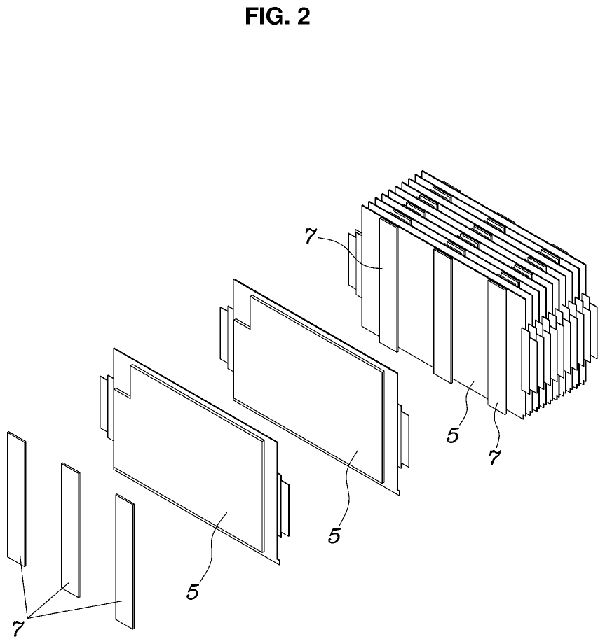

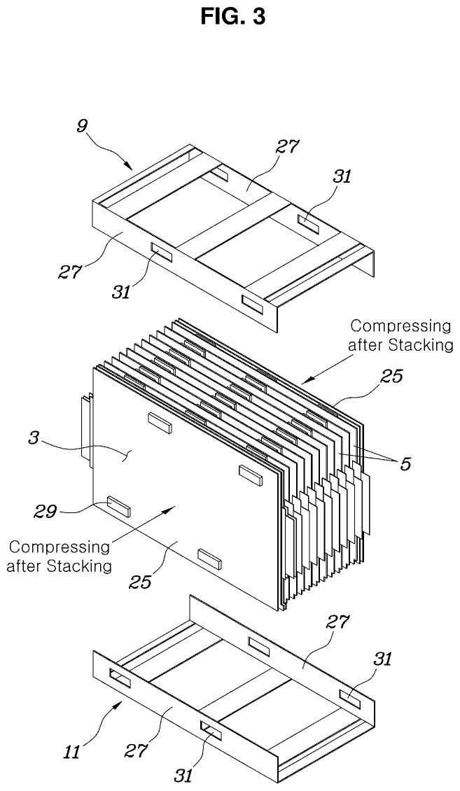

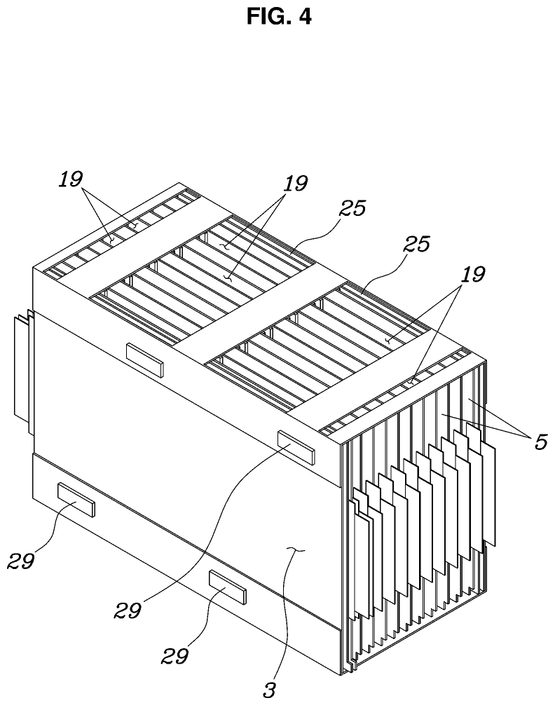

Referring to FIGS. 1 to 4, according to an embodiment of the present invention, a battery module 1 includes two side panels 3, a plurality of battery cells 5 compressed-stacked between the two side panels 3, a plurality of foams 7 inserted between the plurality of battery cells 5, an upper cover plate 9 coupled to the two side panels 3 to restrain a compressed-stacked state of the battery cells 5 at an upper side of the battery cells together with the two side panels, and a lower cover plate 11 coupled to the two side panels 3 to restrain the compressed-stacked state of the battery cells 5 at a lower side thereof together with the two side panels.

Furthermore, sensing boards 15 to which electrodes of the battery cells 5 are connected are respectively provided at tap portions 13 located at opposite sides of the stacked battery cells 5. Sensing board covers 17 covering the sensing boards 15 are provided outside the sensing boards 15.

According to embodiments of the present invention, in stacking the battery cells 5 between the side panels 3, the battery cells 5 are compressed-stacked together with the foams 7 inserted therebetween, without an existing cartridge, etc. The compressed-stacked state of the battery cells is firmly maintained as the upper cover plate 9 and the lower cover plate 11 are coupled to the side panels 3.

Therefore, as the number of components required for maintaining the stacking structure of the battery cells and ensuring the cooling performance is minimized, a manufacturing cost of the battery module is reduced, and the number of the stacked battery cells may be efficiently adjusted. Therefore, the battery module with different output voltages are efficiently configured, so that the request output value may efficiently respond to battery systems with different request output voltages.

In addition, the battery module 1 as described above may be configured such that cooling of the battery cells 5 is efficiently performed through cooling channels 19 provided by the foams 7. When swelling of the battery cells 5 occurs, the foams 7 are configured to absorb the swelling while being further compressed, so that the durability of the battery module is improved. Separate replacement of the battery cells 5 may be easily performed by separating the upper cover plate 9 and the lower cover plate 11 from the side panels 3, so that the excellent maintainability of the battery module 1 is ensured.

The foams 7 and the battery cells 5 may be repeatedly stacked in order of ‘foams-a battery cell-a battery cell’.

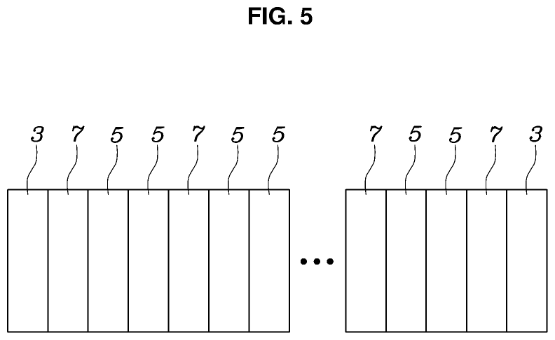

As shown in FIG. 5, the foams 7 and the battery cells 5 stacked in the order of the foams 7, the battery cell 5, the battery cell 5, and the foams 7 are arranged while the side panels 3 compress opposite ends of the foams 7 and the battery cells 5.

The initial compression force achieving the compressed-stacked state of the battery cells 5 is equal to or greater than a predetermined reference compression force, and the foams 7 are inserted between the compressed-stacked battery cells 5 to space the battery cells 5 by equal to or greater than a predetermined minimum cooling interval from each other.

For example, the reference compression force may be preset as 30 kgf, and the minimum cooling interval may be preset to 0.5 mm.

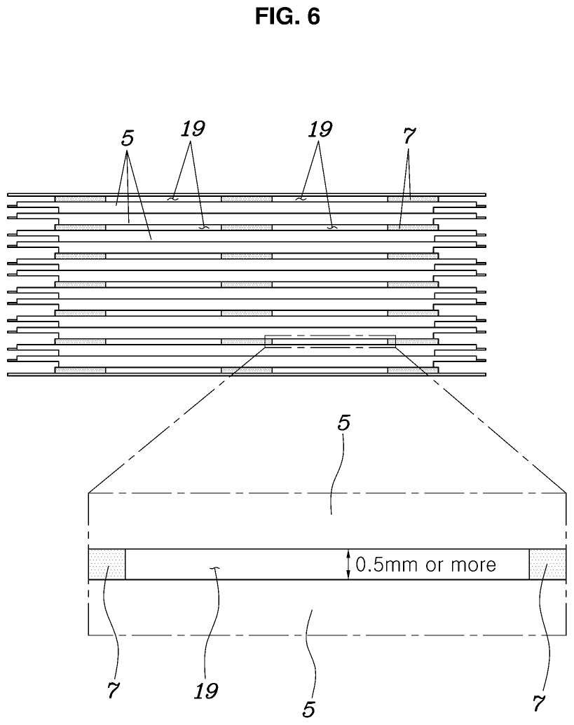

When the upper cover plate 9 and the lower cover plate 11 are assembled with the battery cells 5 and the foams 7 compressed-stacked between the side panels 3, the initial compression force applied from opposite sides of the side panels 3 is preset to be equal to or greater than 30 kgf of the reference compression force. In the assembled state, the interval formed by the foams 7 between the two battery cells 5 is preset to be equal to or greater than 0.5 mm of the minimum cooling interval as shown in FIG. 6.

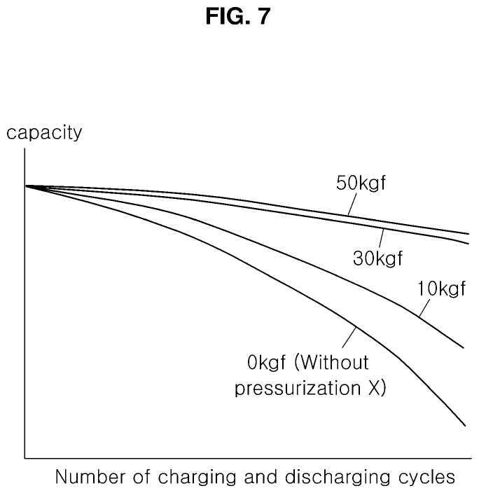

The reference compression force is preset according to the experimental result as shown in FIG. 7. The setting of the reference compression force considers a characteristic in that, when the initial compression force of the foams 7 is equal to or greater than 30 kgf, there is little difference in the tendency of the capacity reduction of the battery module 1 due to increasing of the number of charging and discharging cycles of the battery module 1.

Therefore, the reference compression force may be variable in response to a material of the foams 7.

The minimum cooling interval is provided to allow air to flow into the cooling channels 19, which are formed between the battery cells 5 by the foams 7, so as to efficiently perform an air cooling operation in the battery cells 5. To this effect, the minimum cooling interval may be properly designed by multiple experiments and interpretations.

Preferably, each of the foams 7 is made of a material in which a compression rate thereof is less than or equal to 30% with respect to the reference compression force, and is enabled to be additionally increased to be equal to or higher than 30% as compression force between the battery cells is increased.

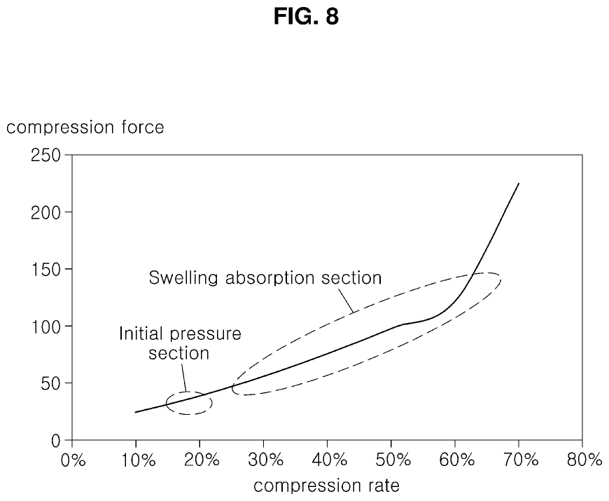

For example, FIG. 8 is a graph showing the relationship between the compression force of a material of each of the foams 7 and the compression rate. When the reference compression force of about 30 kgf is applied, the compression rate of the foams 7 is about 20%. As the compression force applied to the foams 7 is increased, the compression rate of the foams 7 tends to be gradually increased to 70%. Preferably, the foams 7 are made of the material having the same tendency as the graph in FIG. 8.

In the battery module with the foams 7 made of the material as described above, when the swelling in response to the charging and discharging of the battery cells 5 occurs in the battery module 1 assembled with the initial compression force preset adjacent to the reference compression force, a clearance is sufficiently secured for the foams 7 to absorb the swelling while further contracting.

Preferably, the foams 7 contain at least one of urethane and silicone, so that recovery force and repulsive force of the foams 7 may be sufficiently secured.

Furthermore, the foams 7 may be configured to be advantageous for cooling the battery cells 5 by containing at least one of a metal material with excellent thermal conductivity and carbon-based material.

The foams 7 may contain a metal material such as gold, silver, copper, aluminum, etc. having excellent thermal conductivity or a carbon-based material such as graphene, carbon nanotube, etc., so that the thermal conductivity of the foam may be more improved.

Preferably, the foams 7 may be provided to be overlapped with 30% or more of an effective sectional area defined by a cup portion 21 of each of the battery cells 5.

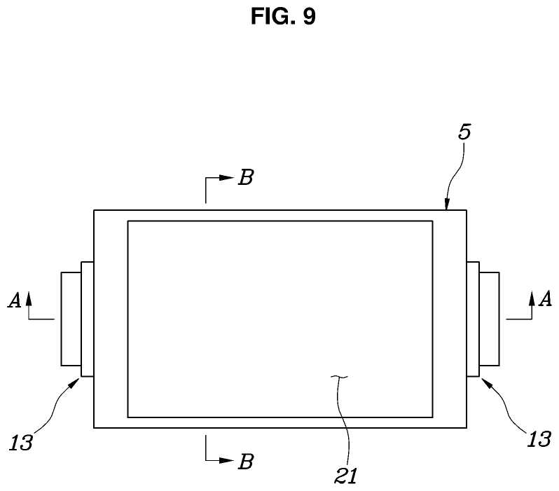

Referring to FIG. 9, in a structure of each of the battery cells 5, the cup portion 21 actually performing a power storing function is located at a center portion of the battery cell and the tap portions 13 to which electrodes of the battery cells are drawn are located at left and right ends thereof.

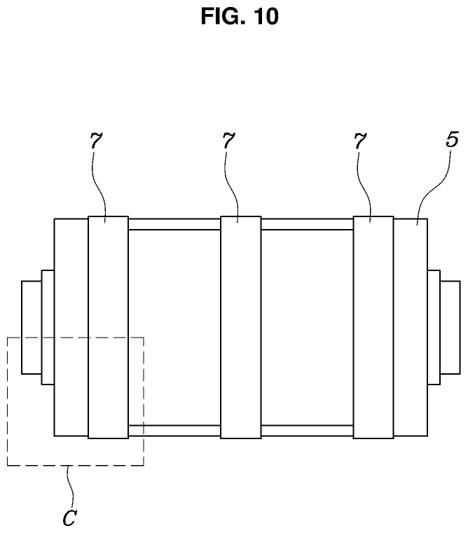

FIG. 10 is a view showing the battery cells 5 with the foams 7 overlapped with each other. Preferably, an area of the foams 7 overlapped with the battery cells 5 may be secured equal to or larger than 30% of the effective sectional area, i.e., of the cup portion 21 of the battery cell 5.

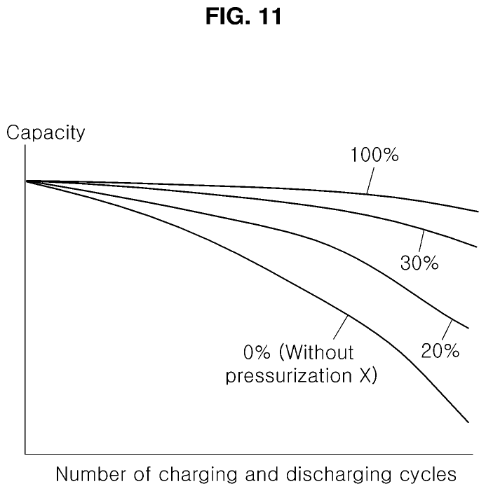

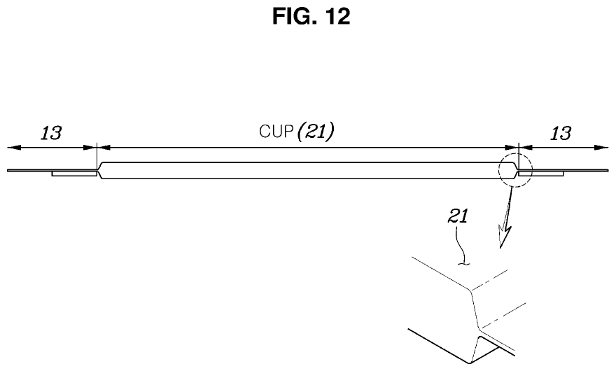

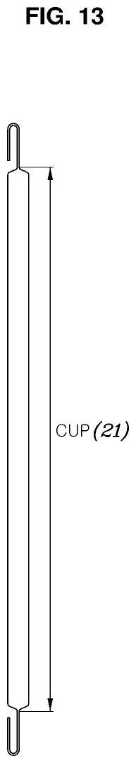

The above structure is designed by reflecting an experimental result as shown in FIG. 11. In the tendency of the capacity reduction of the battery module 1 as the number of the charging and discharging cycles of the battery module 1 is increased, the capacity of the battery module is significantly and sharply reduced when the overlapped area between the battery cells 5 and the foams 7 is less than 30%. In considering the tendency, the foams 7 are configured to be overlapped with the battery cells 5 at 30% or more of the effective sectional area.

Preferably, the plurality of separate foams 7 is inserted between the two battery cells 5 adjacent to each other to form the cooling channels 19 as described above, thereby providing even compression force distribution to the battery cells 5. The foams 7 are arranged to surround an outer edge of the cup portion 21 of the battery cell 5.

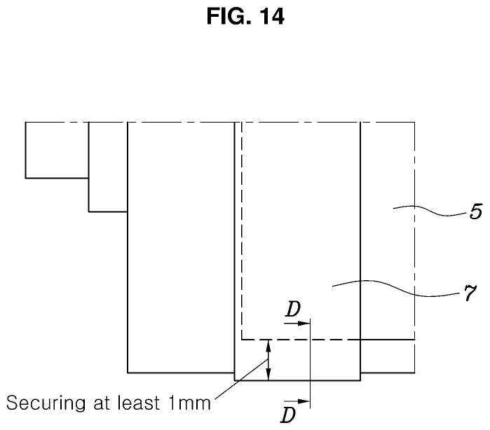

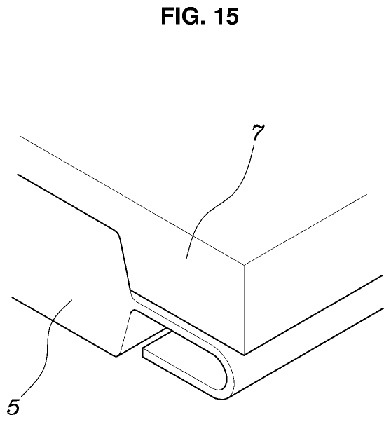

As shown in FIGS. 14 and 15, as the foams 7 are arranged to surround the outer edge of the cup portion 21 while being more extended from the outer edge of the cup portion 21 of the battery cells 5, e.g., by 1 mm or more from the outer edge, the battery cells 5 may be prevented from being moved and being held by the foams 7.

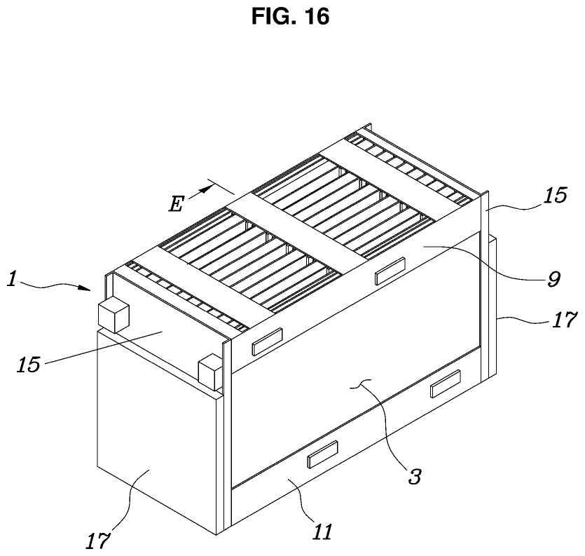

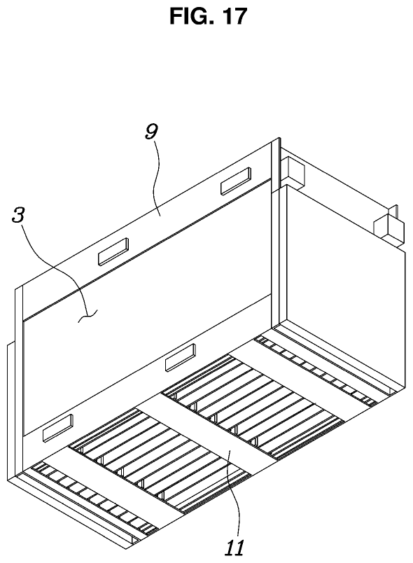

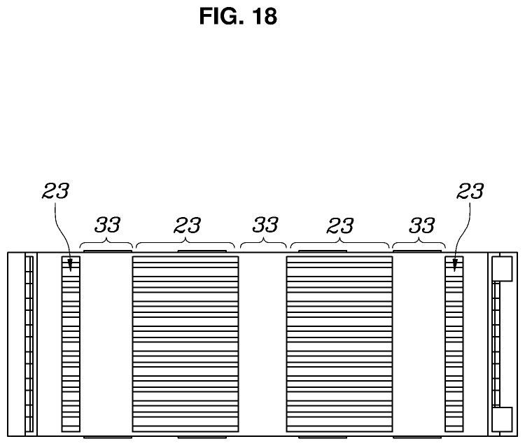

Referring to FIGS. 16 to 19, the upper cover plate 9 and the lower cover plate 11 may respectively have cooling holes 23 that are open to communicate with the cooling channels 19 formed by the foams 7.

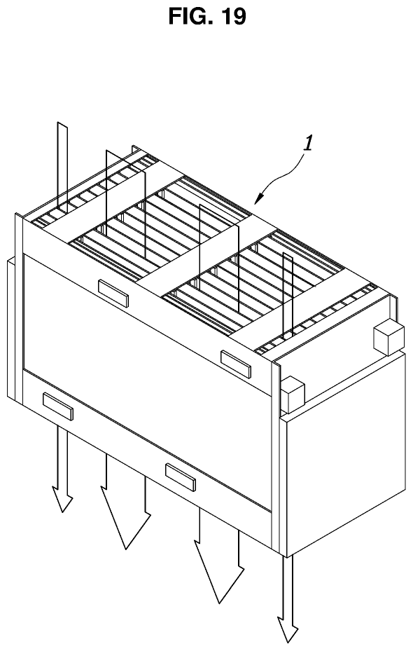

The upper cover plate 9 and the lower cover plate 11 as described above may have the cooling holes 23 communicating with the cooling channels 19 formed between the battery cells 5 by the foams 7, thereby forming the air flow path for cooling indicated by the middle arrows in FIG. 19.

Common use of parts may be promoted as the size of each of the cooling holes 23 of the lower cover plate 11 is formed the same as the size of each of the cooling holes 23 of the upper cover plate 9. In order to ensure more efficient cooling performance, the size of the cooling hole 23 of the lower cover plate 11 may be formed larger than the size of the cooling hole 23 of the upper cover plate 9.

Meanwhile, the upper cover plate 9 and the lower cover plate 11 may have additional cooling holes 23 that are open for communicating with empty spaces formed by the tap portions 13 of the battery cells 5.

The battery cells 5 may be more efficiently cooled by the additional cooling holes 23. Arrows at opposite ends in FIG. 19 indicate flow paths of air flowing through the tap portions 13 of the battery cells 5.

The side panels 3 have upper and lower protrusions 25 at upper and lower ends thereof. The upper and lower protrusions 25 may be integrally formed in the side panels 3 to be inserted into the cooling holes 23 of the upper cover plate 9 and the lower cover plate 11.

Each of the upper cover plate 9 and the lower cover plate 11 has wings 27 formed to cover upper and lower end portions of the side panel 3.

The side panel 3 has locking protrusions 29 protruding toward the wings 27 of the upper cover plate 9 and the lower cover plate 11. The wings 27 of each of the upper cover plate 9 and the lower cover plate 11 may have locking holes 31 into which the locking protrusions 29 are inserted.

Therefore, as described above when the upper cover plate 9 and the lower cover plate 11 are respectively coupled to the upper and lower portions of the battery cells 5 compressed-stacked by the opposite side panels 3, the upper and lower protrusions 25 of the side panels 3 are inserted into the cooling holes 23 so that the upper and lower protrusions 25 and the cooling holes 23 restrain each other. As the locking protrusions 29 are inserted into the locking holes 31 to restrain the locking protrusions 29 and the wings 27 together, the coupling state between the side panels 3, the upper cover plate 9, and the lower cover plate 11 in which the battery cells 5 are stacked is firmly achieved.

Meanwhile, a bridge 33 provided between the cooling holes 23 of each of the upper cover plate 9 and the lower cover plate 11 may be preferably formed to have the width larger than the width of each of the foams 7.

As the actual air flow sectional area of the cooling channels 19 formed by the foams 7 is not increased even when the width of the bridge 33 is less than the width of each of the foams 7, the width of the bridge is preset in order to prevent unnecessary hardness reduction of each of the upper cover plate 9 and the lower cover plate 11.

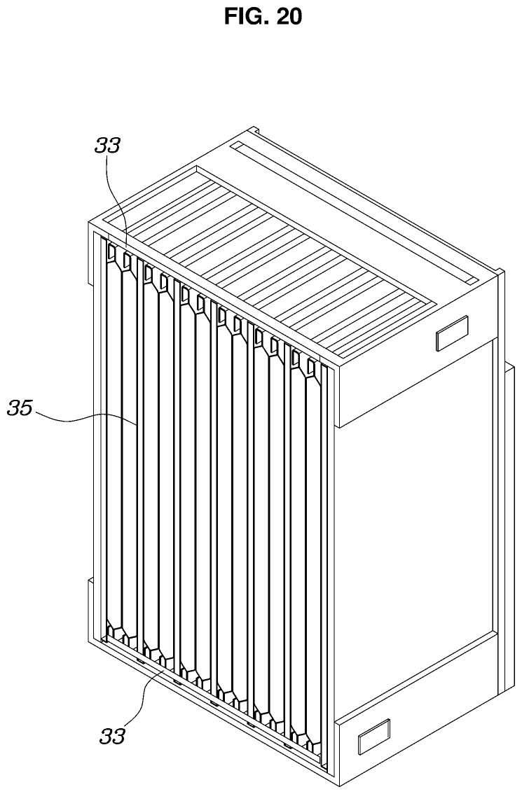

In addition, referring to FIG. 20, a gap between the bridge 33 of each of the upper cover plate 9 and the lower cover plate 11 and each of the foams 7 may be filled with a filling material 35 for removing an empty space.

Resin may be used as the filling material 35. As the filling material 35 is filled, a flow of air flowing through the cooling holes 23 may not be dispersed and may be concentrated to the cooling channels 19 between the battery cells 5, and ultimately the cooling performance of the battery cells 5 may be improved.

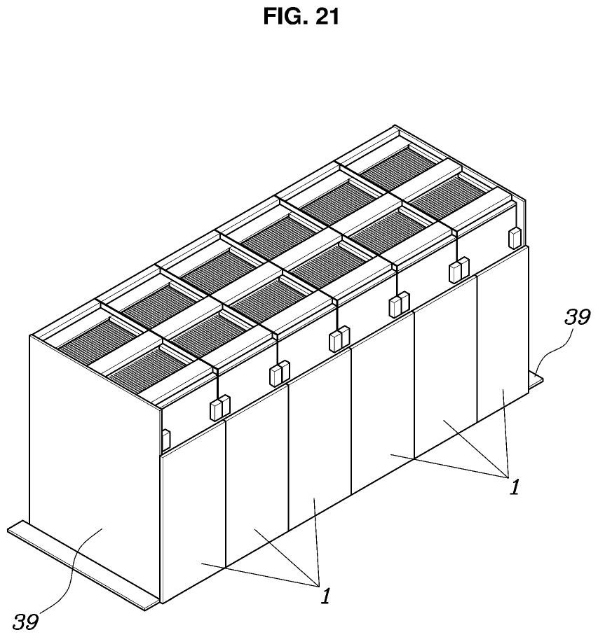

FIG. 21 is a view showing a battery system 37 configured while using the battery module 1 as described above. End plates 39 are respectively provided at opposite ends of a plurality of stacked battery modules 1.

The above configuration may be used when each of the battery modules 1 is small in the size due to the thin thickness of each of the battery cells 5 of the battery module 1 or when an output voltage required for the battery system is low and the battery system consists of a small number of the battery modules 1.

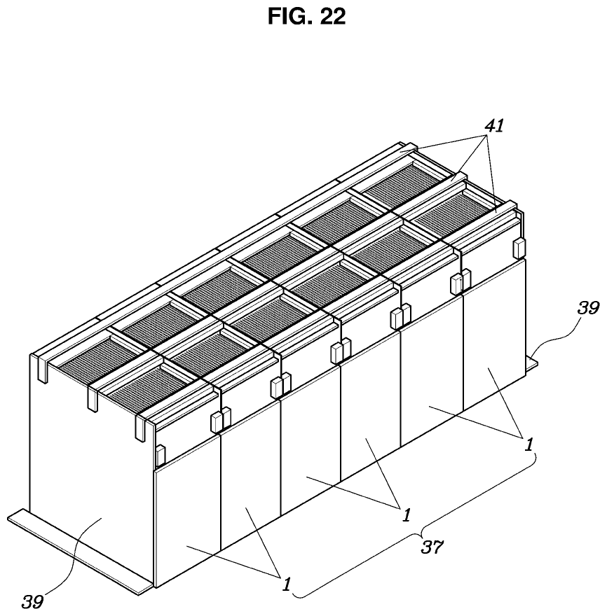

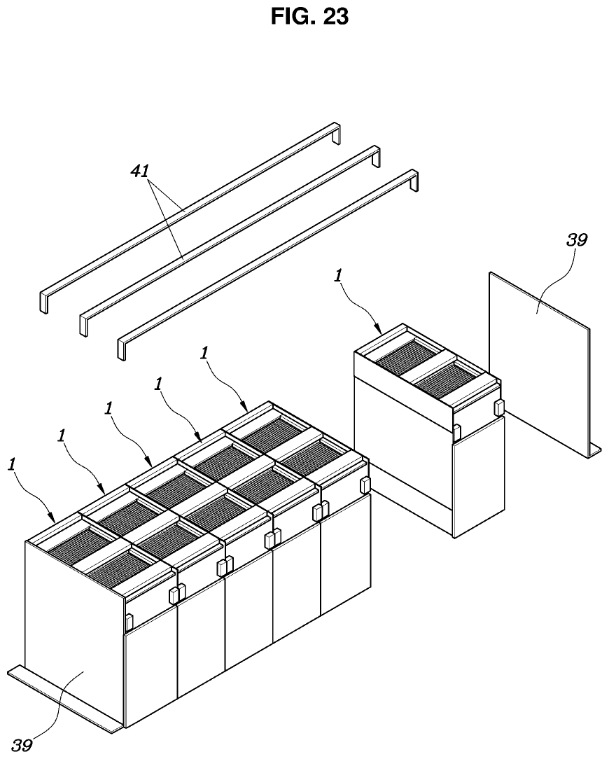

Meanwhile, the battery module 1 is relatively large in size in the battery system due to the thick thickness of the battery cell 5 constituting the battery module 1, and when the battery system consists of a large number of the battery modules 1, straps 41 may be used to integrally hold the end plates 39 and the battery modules 1 as the end plates 39 are connected to the opposite ends of the stacked battery module 1 as shown in FIGS. 22 and 23.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A battery module comprising:
two side panels;
a plurality of battery cells stacked between the two side panels;
a plurality of foams inserted between the battery cells;
an upper cover plate coupled to the two side panels to restrain a compressed-stacked state of the battery cells at an upper side of the battery cells in combination with the two side panels; and
a lower cover plate coupled to the two side panels to restrain the compressed-stacked state of the battery cells at a lower side of the battery cells in combination with the two side panels.

2. The battery module of claim 1, wherein the foams and the battery cells are repeatedly stacked in order of ‘foams—a battery cell—a battery cell’.

3. The battery module of claim 1, wherein:
an initial compression force is equal to or greater than a predetermined reference compression force; and
the foams are inserted between the battery cells such that the battery cells in the compressed-stacked state are spaced apart from each other by a predetermined minimum cooling interval or more.

4. The battery module of claim 3, wherein each of the foams comprises a material having a compression rate of less than or equal to 30% with respect to the reference compression force and capable of being increased to be equal to or higher than 30% as compression force between the battery cells is increased.

5. The battery module of claim 4, wherein each of the foams comprises urethane or silicone.

6. The battery module of claim 5, wherein each of the foams comprises a thermally conductive metal material or a carbon-based material.

7. The battery module of claim 1, further comprising:
sensing boards respectively provided at tap portions at opposite sides of the stacked battery cells, the sensing boards being connected to electrodes of the battery cells; and
sensing board covers located outside the sensing boards while surrounding the sensing boards.

8. A battery module comprising:
two side panels;
a plurality of battery cells stacked between the two side panels;
a plurality of foams inserted between the battery cells, wherein the foams are arranged to be overlapped with 30% or more of an effective sectional area comprising a cup portion of each of the battery cells;
an upper cover plate coupled to the two side panels and configured to restrain a compressed-stacked state of the battery cells at an upper side of the battery cells in combination with the two side panels; and
a lower cover plate coupled to the two side panels and configured to restrain the compressed-stacked state of the battery cells at a lower side of the battery cells in combination with the two side panels.

9. The battery module of claim 8, wherein the foams inserted between two battery cells adjacent to each other comprise a plurality of separate foams configured to define cooling channels between two battery cells.

10. The battery module of claim 9, wherein the foams are arranged to surround an outer edge of the cup portion of the respective battery cell.

11. The battery module of claim 9, wherein each of the upper cover plate and the lower cover plate comprises cooling holes that are open to communicate with the cooling channels defined by the foams.

12. The battery module of claim 11, wherein each of the cooling holes of the lower cover plate is larger in size than a size of each of the cooling holes of the upper cover plate.

13. The battery module of claim 11, wherein each of the upper cover plate and the lower cover plate comprises additional cooling holes that are open to communicate with empty spaces defined by tap portions of the battery cells.

14. The battery module of claim 13, wherein each of the side panels comprises upper and lower protrusions integrally formed on upper and lower ends thereof, the upper and lower protrusions configured to be inserted into the cooling holes of the upper cover plate and the lower cover plate.

15. The battery module of claim 13, wherein the upper cover plate and the lower cover plate respectively comprise wings integrally formed thereon to cover upper and lower end portions of the side panels.

16. The battery module of claim 15, wherein:
each of the side panels comprises locking protrusions protruding toward the wings of the upper cover plate and the lower cover plate; and
the wings of the upper cover plate and the lower cover plate respectively have locking holes configured to receive the locking protrusions.

17. The battery module of claim 11, further comprising bridges arranged between the cooling holes of each of the upper cover plate and the lower cover plate, wherein each of the bridges has a width equal to or greater than a width of each of the foams.

18. The battery module of claim 17, further comprising a filling material provided in spaces between the foams and the bridges of each of the upper cover plate and the lower cover plate.

19. A battery system comprising:
a plurality of battery modules stacked adjacent to one another to define a stack of the battery modules, each of the battery modules comprising:
a plurality of battery cells stacked between two side panels;
a plurality of foams inserted between the battery cells;
an upper cover plate coupled to the two side panels and configured to restrain a compressed-stacked state of the battery cells at an upper side of the battery cells in combination with the two side panels; and
a lower cover plate coupled to the two side panels and configured to restrain the compressed-stacked state of the battery cells at a lower side of the battery cells in combination with the two side panels; and
end plates respectively located at opposite ends of the stack of the battery modules.

20. The battery system of claim 19, further comprising straps configured to connect the end plates to each other at the opposite ends of the stack of the battery modules, wherein the straps are configured to integrally hold the end plates and the battery modules.
